(19) United States
(12) Patent Application Publication
(10) Pub. No.: US 2011/0038986 A1
(43) Pub. Date: Feb. 17, 2011

(54) Vitamin package and delivery method

(76) Inventor: Steven R. Sponder, Boca Raton, FL (US)

Correspondence Address: ROBERT M. DOWNEY, P.A., 6751 N. FEDERAL HWY., SUITE 300, BOCA RATON, FL, 33487, US

(21) Appl. No.: 12/806,324

(22) Filed: Aug. 10, 2010

Related U.S. Application Data
(60) Provisional application No. 61/274,492, filed on Aug. 17, 2009.

(51) Int. Cl. A23L 1/302; B65D 65/00

(52) U.S. Cl. 426/72; 426/410

(57) ABSTRACT

A daily multivitamin is packaged in inexpensive paper sachets (i.e. packets) similar to any familiar tabletop sugar sachets or sweetener sachets and is delivered as a flavor-free and clearly dissolving powder for addition to a beverage or food item. The multivitamin formula provides 100% of the United States Government's Recommended Daily Amount (RDA) of essential vitamins and minerals within a single dosage sachet. The powder particles containing one or more vitamins are micro-encapsulated to conceal the undesirable vitamin flavor. The inner surfaces of the sachets are poly-coated to protect the powder composition from moisture. The sachets are intended to be sold in bulk to businesses and institutions which provide them for free, identical to how sugar, sweeteners and condiments are currently provided for free at such establishments. The sachets containing the single dosage of the multivitamin powder composition are also intended to be sold at retail to consumers.

### BACKGROUND OF THE INVENTION

This application is based on provisional patent application Ser. No. 61/274,492 filed on Aug. 17, 2009.

### FIELD OF THE INVENTION

The present invention relates to nutritional supplements and, more particularly, to a daily multivitamin delivered as a flavor-free and clearly dissolving powder from inexpensive paper sachets (i.e. packets).

### DISCUSSION OF THE RELATED ART

Multivitamins provide a supplement of important vitamins and minerals to a consumer's diet. Reasons for using a multivitamin may vary from dietary imbalances to pregnancy, however the most common use of multivitamins is to supplement a normal diet to supply any important vitamins that a consumer may not have received throughout their day. Rising healthcare costs have caused an increase in multivitamin consumption, since many health problems can be caused by vitamin deficiencies. Most multivitamins are sold as containers of pills to be taken once per day, however these pills are usually quite expensive and many consumers are not willing to pay the high price for them. Even for those who can afford multivitamins, there are several downsides associated with taking a multivitamin such as the inconvenience of having to take a pill every day and the bad aftertaste following a pill.

In view of the shortcomings associated with existing multivitamin packaging and delivery systems, there remains a need for a multivitamin delivery system which provides a flavor-free and clearly dissolving multivitamin which is convenient to administer and free to obtain for the consumer, and which is also profitable for the manufacturer and retailer.

### Objects and Advantages of the Invention

Considering the foregoing, it is a primary object of the present invention to provide a daily multivitamin in the form of a generally flavor-free and clearly dissolving which can dissolve into a beverage to provide a daily supplement of vitamins and minerals upon consumption.

It is a further object of the present invention to provide a daily multivitamin in the form of a flavor-free and clearly dissolving powder, as described above, which uses micro-encapsulated vitamins to achieve the flavor-free and clearly dissolving powder form.

It is still a further object of the present invention to provide a daily multivitamin in the form of a powder substance that quickly dissolves into a beverage without altering the color or flavor of the beverage.

It is still a further object of the present invention to provide a daily multivitamin in the form of a flavor-free and clearly dissolving powder, as described above, which can be packaged in inexpensive paper sachets identical to the familiar sugar and sweetener sachets found in most beverage establishments.

It is still a further object of the present invention to provide a daily multivitamin in the form of a flavor-free and clearly dissolving powder to be packaged in inexpensive paper sachets, as described above, in which the interior surface of the paper sachets can be poly-coated to prevent moisture from penetrating the sachet and mixing with the powder.

It is still a further object of the present invention to provide a daily multivitamin in the form of a flavor-free and clearly dissolving powder to be packaged in inexpensive paper sachets, as described above, in which the paper sachets can be colored and can naturally fit in with familiar sachets already found on tables.

It is still a further object of the present invention to provide a daily multivitamin in the form of a flavor-free and clearly dissolving powder, as described above, which provides 100% of the United States Government's Recommended Daily Amount (RDA) of selected essential vitamins and minerals within each individual paper sachet.

It is still a further object of the present invention to provide a daily multivitamin in the form of a flavor-free and clearly dissolving powder, as described above, which does not in any way compete with existing sugar or sweetener sachets, but is instead used as an accompaniment to these sachets.

It is still a further object of the present invention to provide a daily multivitamin in the form of a flavor-free and clearly dissolving powder, as described above, which can be sold wholesale at about one penny per sachet, a price point which is comparable to current tabletop sweeteners.

It is still a further object of the present invention to provide a daily multivitamin in the form of a flavor-free and clearly dissolving powder, as described above, which can be given away for free to customers at beverage establishments, restaurants etc.

These and other objects and advantages of the present invention are more readily apparent with reference to the detailed description.

### SUMMARY OF THE INVENTION

The present invention is directed to a daily multivitamin which is delivered in the form of a flavor-free and clearly dissolving powder and which is packaged in inexpensive paper sachets (i.e. packets) identical to the sugar and sweetener sachets already found at modern beverage establishments, restaurants etc. The formula for this multivitamin provides 100% of the U.S. Government's Recommended Daily Allowance (RDA) of essential vitamins and minerals within each individual paper sachet. The paper sachets themselves have poly-coated interior surfaces to prevent moisture from entering the interior of the sachet and mixing with the powder. In addition, the sachet are optionally colored to be visually aesthetic and to match the theme of familiar yellow, blue and pink tabletop sweetener sachets. One or more of the vitamins in the formula are micro-encapsulated to provide the flavor-free and clearly dissolving powder delivery method in addition to allowing the multivitamin to dissolve into a beverage. The present invention can be sold in bulk to retailers such as beverage establishments, restaurants etc. who can then offer the sachets to customers for free in the same manner in which sugar, sweeteners and condiments are currently offered for free. Food and beverage establishments will gladly provide these sachets for free because it helps them achieve their goal of repeat customer visits. These businesses will benefit because consumers who would rather not pay for their own multivitamins will be more inclined to visit their favorite local beverage establishments where they can purchase a beverage and get their daily multivitamin for free.

### BRIEF DESCRIPTION OF THE DRAWINGS

For a fuller understanding of the nature of the present invention, reference should be made to the following detailed description taken in conjunction with the accompanying drawings in which:

FIG. 1 is a top plan view illustrating the poly-lined sachet for storing a single dose of the multivitamin powder of the present invention.

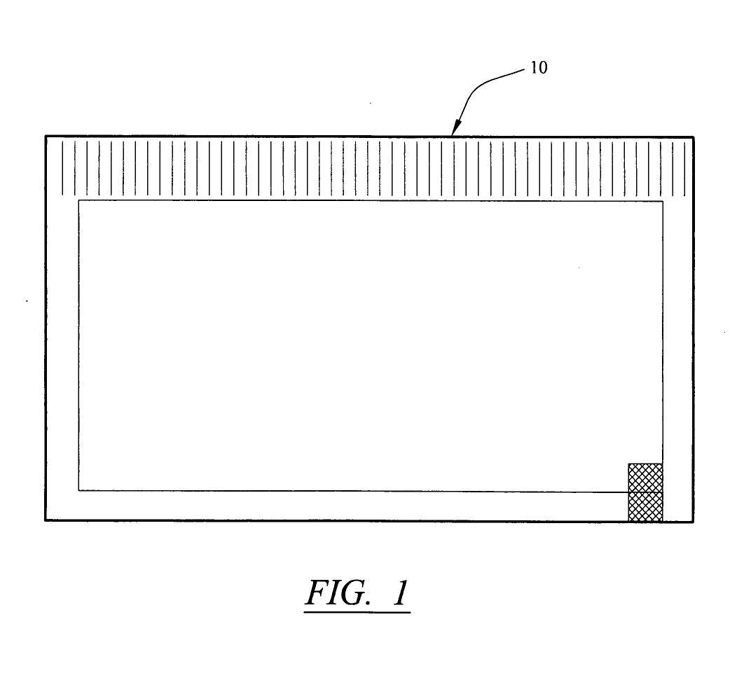

### DETAILED DESCRIPTION OF THE PRESENT INVENTION

A formula for a daily multivitamin and multi-mineral mixture provides 100% of the United States Government's Recommended Daily Amount (RDA) of essential vitamins and minerals in an approximately one gram serving sized paper sachet 10 (i.e., packet). The vitamins and minerals of the formula are micro-encapsulated to form a flavor-free and clearly dissolving powder which can be dissolved into a beverage to provide the full benefit of the vitamins and minerals upon consumption of the beverage without affecting the taste or color of the beverage. The multivitamin dissolves clearly in coffee, tea, water, juice, milk and other beverages.

Several embodiments of the multivitamin powder have been considered. In a first embodiment, the multivitamin powder includes Vitamin C, Thiamin (Vitamin B1), and Pantothenic Acid. In another embodiment, the multivitamin powder includes Vitamins C, A, B1, B3, B5, B6, B7, B12, D, E, and K.

The multivitamin powder is delivered in the approximately one gram inexpensive paper sachets 10 similar to the familiar tabletop sugar and sweetener sachets provided at restaurants, coffee shops and other commercial establishments. The sachets 10 have poly-coated interior surfaces to prevent any moisture from entering the interior of the sachet 10 and mixing with the powder. The approximately one gram of powder containing one or more vitamins in each sachet 10 will provide 100% of the RDA of each vitamin. Sachets 10 may be colored and/or designed to fit in with similar familiar sweetener and sugar sachets. The present invention is substantially flavor-free, clearly dissolving and non-sweetened, thereby accompanying sugar and sweeteners as opposed to competing with them. It is, therefore, contemplated that the multivitamin powder of the present invention be combined with a sugar or artificial sweetener within a single sachet.

The vitamin product of the present invention may be sold wholesale at approximately one penny per sachet 10, thereby making it an extremely cost-effective tool to help attract more customers seeking an establishment's most profitable product, namely beverages. Food and beverage establishments may provide the sachets 10 for free as a compliment to consumers' orders. Because many consumers insist on taking a multivitamin daily but do not want to pay the high price for multivitamin pills or liquid formulations, this will help retailers by encouraging customers to make visits to their establishment on a more regular and daily basis.

It is further contemplated that the multivitamin powder composition will be sold in bulk to food manufacturers as an additive to the ingredients of various food products.

Consumers will prefer the present invention to alternative methods of taking a daily multivitamin because the product of the present invention is more convenient than having to swallow a pill, it has no bitter or unpleasant aftertaste, it can be easily dissolved into a consumer's favorite beverage and, perhaps most importantly, it can be obtained by the consumer for free.

While the present invention has been shown in accordance with a preferred and practical embodiment, it is recognized that departures from the instant disclosure are fully contemplated within the spirit and scope of the present invention.

What is claimed is:

1. A single dose of vitamin product comprising:
a granulated powder vitamin composition containing one or more essential vitamins and minerals and said granulated powder vitamin composition being micro-encapsulated to mask the flavor and smell of the vitamin composition, and said granulated powder vitamin composition being structured and disposed for transparently dissolving when added to a beverage or food product; and
a sachet for storing a single dose of said granulated powder vitamin composition and said sachet having inner surfaces lined with a moisture impervious coating to prevent moisture from coming into contact with said granulated powder vitamin composition contained therein.

2. A method of delivering a single dose of vitamin product to a user comprising the steps of:
providing a granulated powder vitamin composition containing one or more essential vitamins and minerals;
micro-encapsulating granules of the powder vitamin composition to mask the flavor of the one or more vitamins and minerals;
packaging this powder vitamin composition in single dosage paper sachets having inner surfaces lined with a moisture impervious coating; and
adding the single serving of the powder vitamin composition to a beverage or food product prior to consumption.

3. The method recited in claim 2 further comprising the step of:
placing the paper sachets containing the single servings of the powder vitamin composition in an easily accessible location at a commercial establishment.

4. The method recited in claim 3 wherein said step of placing the paper sachets further comprises placing the paper sachets with similar paper sachets containing natural and artificial sweeteners for convenient adding to beverages along with the natural and artificial sweeteners.
